(19) United States
(12) Patent Application Publication
(10) Pub. No.: US 2018/0348792 A1
(43) Pub. Date: Dec. 6, 2018

(54) SYSTEMS AND METHODS FOR COUPLING AUTONOMOUS GROUND VEHICLES DELIVERING MERCHANDISE

(71) Applicant: Walmart Apollo, LLC, Bentonville, AR (US)

(72) Inventor: John J. O'Brien, Farmington, AR (US)

(21) Appl. No.: 15/993,822

(22) Filed: May 31, 2018

Related U.S. Application Data
(60) Provisional application No. 62/515,777, filed on Jun. 6, 2017.

(51) Int. Cl. G05D 1/02; G05D 1/00; B60D 99/00; G01C 21/20; G06Q 10/08

(52) U.S. Cl. CPC G05D 1/0293; G05D 1/0088; G05D 1/0246; G05D 2201/0216; B60D 7/00; G01C 21/206; G06Q 10/083; G05D 1/0297

(57) ABSTRACT

In some embodiments, apparatuses and methods are provided herein useful to forming chains of autonomous ground vehicles (AGVs) for delivering merchandise. In some embodiments, there is provided a system including: a plurality of AGVs with each AGV having a motorized locomotion system, a storage area, first and second magnetic connectors at ends of a vehicle body, a transceiver, an optical sensor, and a control circuit that activates and deactivates the magnetic connectors; a subset of the AGVs defining a chain; an unlinked AGV; a database containing images of the vehicle body; and a master control circuit that receives an authentication code from the unlinked AGV, determines that the authentication code is authorized, determines position, speed, and direction of the chain of AGVs and the unlinked AGV, compares images to determine proximity and orientation of the unlinked AGV, and activates a magnetic connector to link the unlinked AGV to the chain.

### CROSS-REFERENCE TO RELATED APPLICATION

This application claims the benefit of U.S. Provisional Application No. 62/515,777, filed Jun. 6, 2017, which is incorporated by reference in its entirety herein.

### TECHNICAL FIELD

This invention relates generally to autonomous ground vehicles (AGVs), and more particularly, to AGVs delivering merchandise to customers.

### BACKGROUND

In the retail sector, one important challenge is the delivery of merchandise to customers. Currently, in one form, merchandise may be delivered by employees or third party carriers operating delivery trucks or other vehicles, which may be expensive or pursuant to a limited schedule. In another form, in certain circumstances, a customer may be required to pick up desired merchandise at a shopping facility, which may constitute an inconvenience to the customer. Accordingly, retailers are often investigating alternative ways of delivering merchandise.

One alternative delivery mechanism that is being developed is the use of autonomous ground vehicles (AGVs) to deliver the merchandise. There are some advantages to having AGVs travel in chains of AGVS when making deliveries, including the potential sharing and conserving of resources such as power sharing and navigation. Accordingly, it is desirable to develop approaches where unlinked AGVs can selectively link to other AGVs to form a chain and to selectively unlink from the chain.

### BRIEF DESCRIPTION OF THE DRAWINGS

Disclosed herein are embodiments of systems, apparatuses and methods pertaining to forming chains of autonomous ground vehicles (AGVs) for delivering merchandise. This description includes drawings, wherein:

FIG. 1 is a schematic diagram in accordance with some embodiments;

FIG. 2 is a block diagram in accordance with some embodiments;

FIG. 3 is a flow diagram in accordance with some embodiments;

FIGS. 4 and 5 are schematic diagrams showing electromagnetic connectors for coupling AGVs in accordance with some embodiments; and

FIGS. 6 and 7 are schematic diagrams showing multi-pole magnetic connectors for coupling AGVs in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to delivering merchandise using autonomous ground vehicles (AGVs) linking to other AGVs. In some embodiments, there is provided a system comprising: a plurality of AGVs with each AGV including: a motorized locomotion system configured to facilitate movement of the AGV; a storage area configured to hold at least one merchandise item; a vehicle body having a first end and a second end; a power source disposed in the vehicle body; a first magnetic connector at the first end of the vehicle body and configured for linking to a magnetic connector of another AGV; a second magnetic connector at the second end of the vehicle body and configured for linking to a magnetic connector of another AGV; a transceiver configured for wireless communication and configured to transmit an authentication code; an optical sensor configured to capture a plurality of images; and a first control circuit configured to selectively activate the first and second magnetic connectors for linking to other AGVs and to selectively deactivate the first and second connectors for disconnecting from other AGVs; a subset of the plurality of AGVs defining a chain of AGVs moving in a direction of travel to deliver merchandise; an unlinked AGV of the plurality of AGVs to be linked to an AGV at an end of the chain of AGVs; a database containing a plurality of predetermined images of the first end of the AGV vehicle body and of the second end of the AGV vehicle body; and a second control circuit configured to: receive an authentication code from the unlinked AGV; determine that the authentication code from the unlinked AGV is an authorized authentication code to allow linking of the unlinked AGV to the chain of AGVs; determine a first position, first speed, and first direction of the end AGV at the end of the chain of AGVs to be linked to the unlinked AGV; determine a second position, second speed, and second direction of movement of the unlinked AGV; calculate and transmit a third speed and third direction of movement to the unlinked AGV to facilitate approach to the end AGV; receive a plurality of images from the optical sensor of one or both of the unlinked AGV and the end AGV; compare the received plurality of images with predetermined images from the database using image recognition of predetermined features of the first and second ends of the AGV vehicle body to determine a proximity and orientation of the unlinked AGV with respect to the end AGV on approach to link; and instruct the activation of a magnetic connector of one or both of the unlinked AGV and the end AGV to link the unlinked AGV to the end AGV when the unlinked AGV is within a predetermined proximity and orientation to the end AGV.

In the system, the second control circuit may be physically located at a command and control center remote from the chain of AGVs, the second control circuit in wireless communication with each first control circuit of the plurality of AGVs. Alternatively, the second control circuit may define a unitary and master control circuit with one of the first control circuits of the linked AGVs.

Further, in the system, each first magnetic connector of an AGV may comprise a first coiled wire coupled to the AGV power source and receiving current, the first coiled wire wrapped around a first metal core to define a first electromagnetic connector; each second magnetic connector of the AGV may comprise a second coiled wire coupled to the AGV power source and receiving current, the second coiled wire wrapped around a second metal core to define a second electromagnetic connector; and each first control circuit may be configured to selectively adjust the polarity of the first electromagnetic connector or the second electromagnetic connector by adjusting the current through the first coiled wire or the second coiled wire.

Alternatively, in the system, each first magnetic connector of an AGV may comprise a first coiled wire coupled to the AGV power source and receiving current, the first coiled wire wrapped around a first metal core to define a first electromagnetic connector; each second magnetic connector of the AGV may comprise a second coiled wire coupled to the AGV power source and receiving current, the second coiled wire wrapped around a second metal core to define a second electromagnetic connector; and each first control circuit may be configured to selectively reverse the polarity of the first electromagnetic connector or the second electromagnetic connector.

Moreover, in the system, each first and second magnetic connector of each AGV of the plurality of AGV may comprise a first and second multi-pole magnetic connector, each first and second multi-pole magnetic connector having two north poles alternating with two south poles. In addition, each multi-pole magnetic connector may have a first predetermined orientation; may have a second predetermined orientation corresponding to a predetermined degree of rotation from the first orientation; each multi-pole magnetic connector in the first predetermined orientation may attract another multi-pole magnetic connector in the second predetermined orientation; and each multi-pole magnetic connector in the first predetermined orientation may repel another multi-pole magnetic connector in the first predetermined orientation.

Also, in the system, each AGV may comprise a navigational system including: a GPS unit configured to facilitate navigation of the AGV vehicle body; and an ultra-wideband unit configured to facilitate navigation to and connection with the other AGVs of the plurality of AGVs. Further, in the system, a first AGV may be linked to a second AGV in the plurality of AGVs; and the first control circuit of the first AGV may be configured to transfer power from its power source to the second AGV through magnetic coupling between the first and second AGVs.

In addition, in the system, the second control circuit may be configured to: communicate with the first control circuit of each AGV of the plurality of AGVs; and instruct the first control circuit of each AGV to selectively connect with other AGVs to form a chain of AGVs and to selectively disconnect from other AGVs to unchain. Moreover, in the system, the second control circuit may be configured to: detect an obstacle in a direction of travel of the linked AGVs; and communicate with the first control circuits of the AGVs instructing them to selectively disconnect from other AGVs to avoid the obstacle.

In another form, there is provided a method of delivering merchandise using AGVs linking to other AGVs, the method comprising: providing a plurality of AGVs with each AGV including: a motorized locomotion system configured to facilitate movement of the AGV; a storage area configured to hold at least one merchandise item; a vehicle body having a first end and a second end; a power source disposed in the vehicle body; a first magnetic connector at the first end of the vehicle body and configured for linking to a magnetic connector of another AGV; a second magnetic connector at the second end of the vehicle body and configured for linking to a magnetic connector of another AGV; a transceiver configured for wireless communication and configured to transmit an authentication code; an optical sensor configured to capture a plurality of images; and a first control circuit configured to selectively activate the first and second magnetic connectors for linking to other AGVs and to selectively deactivate the first and second connectors for disconnecting from other AGVs; linking a subset of the plurality of AGVs to define a chain of AGVs moving in a direction of travel to deliver merchandise; providing an unlinked AGV of the plurality of AGVs to be linked to an AGV at an end of the chain of AGVs; providing a database containing a plurality of predetermined images of the first end of the AGV vehicle body and of the second end of the AGV vehicle body; and by a second control circuit: receiving an authentication code from the unlinked AGV; determining that the authentication code from the unlinked AGV is an authorized authentication code to allow linking of the unlinked AGV to the chain of AGVs; determining a first position, first speed, and first direction of the end AGV at the end of the chain of AGVs to be linked to the unlinked AGV; determining a second position, second speed, and second direction of movement of the unlinked AGV; calculating and transmitting a third speed and third direction of movement to the unlinked AGV to facilitate approach to the end AGV; receiving a plurality of images from the optical sensor of one or both of the unlinked AGV and the end AGV; comparing the received plurality of images with predetermined images from the database using image recognition of predetermined features of the first and second ends of the AGV vehicle body to determine a proximity and orientation of the unlinked AGV with respect to the end AGV on approach to link; and instructing the activation of a magnetic connector of one or both of the unlinked AGV and the end AGV to link the unlinked AGV to the end AGV when the unlinked AGV is within a predetermined proximity and orientation to the end AGV.

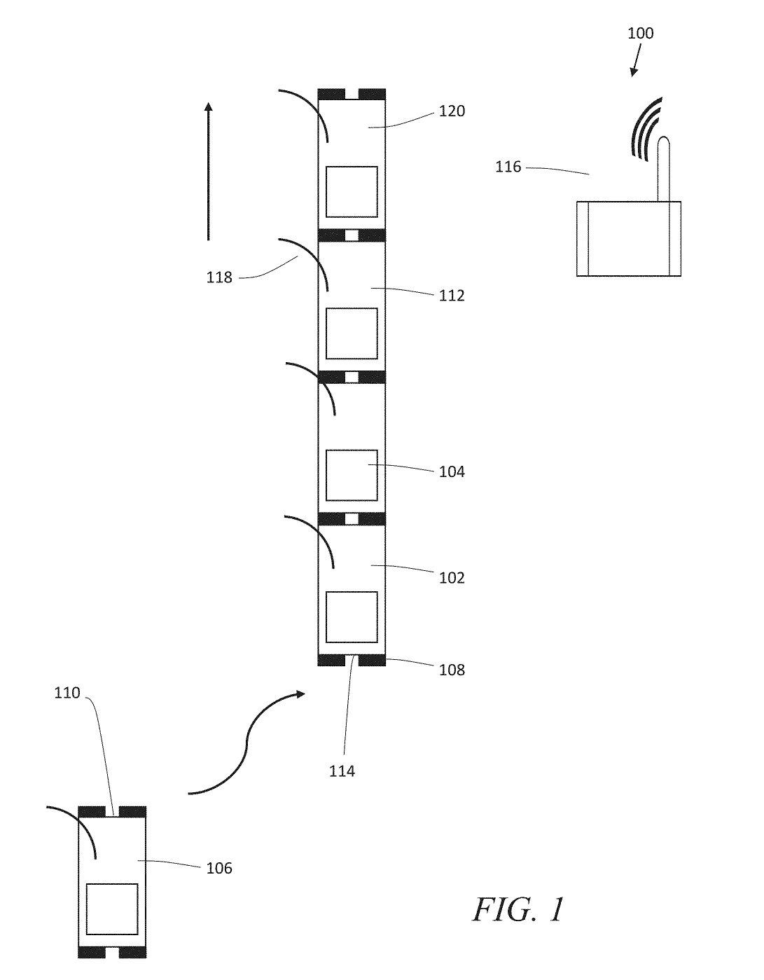

Referring to FIG. 1, there is shown a schematic representation of a delivery system 100 using a chain of AGVs 102. It is generally contemplated that each AGV 102 is delivering merchandise to a specific destination, such as delivering merchandise ordered from a retailer to a customer's business or residence. Each AGV 102 may have a storage area 104 in which to store merchandise for that AGV's particular delivery. There are several advantages to having AGVs 102 make deliveries in a general neighborhood or geographic area travel in a chain of AGVs 102. For example, by having the AGVs 102 travel in a chain, the AGVs 102 are able to share resources with one another, such as the sharing of power between individual AGVs 102 and the sharing of navigational inputs and information between AGVs 102.

In the system 100, it is generally contemplated that the AGVs 102 may selectively link and unlink from one another during travel to their individual delivery locations. As can be seen in FIG. 1, four AGVs 102 are linked to one another to form a chain that is traveling in an upward direction in the figure. In this example, a fifth, unlinked AGV 106 moves to link to the fourth, end AGV 102. As addressed further below, each AGV 102 and 106 includes magnetic connector(s) 108 on the front end 110 of the vehicle body 112 and on the back end 114 of the vehicle body 112. When linking, the unlinked AGV 106 approaches the end AGV 102 and positions itself in close proximity to the end AGV, and the end AGV 102 and unlinked AGV 106 then activate their magnetic connector(s) 108 to attract and link the unlinked AGV 106 to the end of the chain. When unlinking, the fifth AGV 106 may selectively deactivate its magnetic connector(s) 108 to decouple from the chain of AGVs 102, such as when it is approaching its individual delivery destination and is decoupling to complete the delivery.

As can be seen in FIG. 1, in one form, it is contemplated that the system 100 may include a command and control center 116 that communicates with the AGVs 102. Each AGV 102 includes a transceiver 118 with which it may wirelessly communicate with the command and control center 116 and possibly with other AGVs 102. In one form, as addressed further below, it is contemplated that the command and control center 116 may provide, at least, some of the navigational inputs and information to the AGVs 102 to guide the AGVs to their individual delivery locations. However, in another form, it is contemplated that the system 100 may have a “smart” AGV 120 (or “mothership”) that navigates and makes many of the decisions for the chain of AGVs 102.

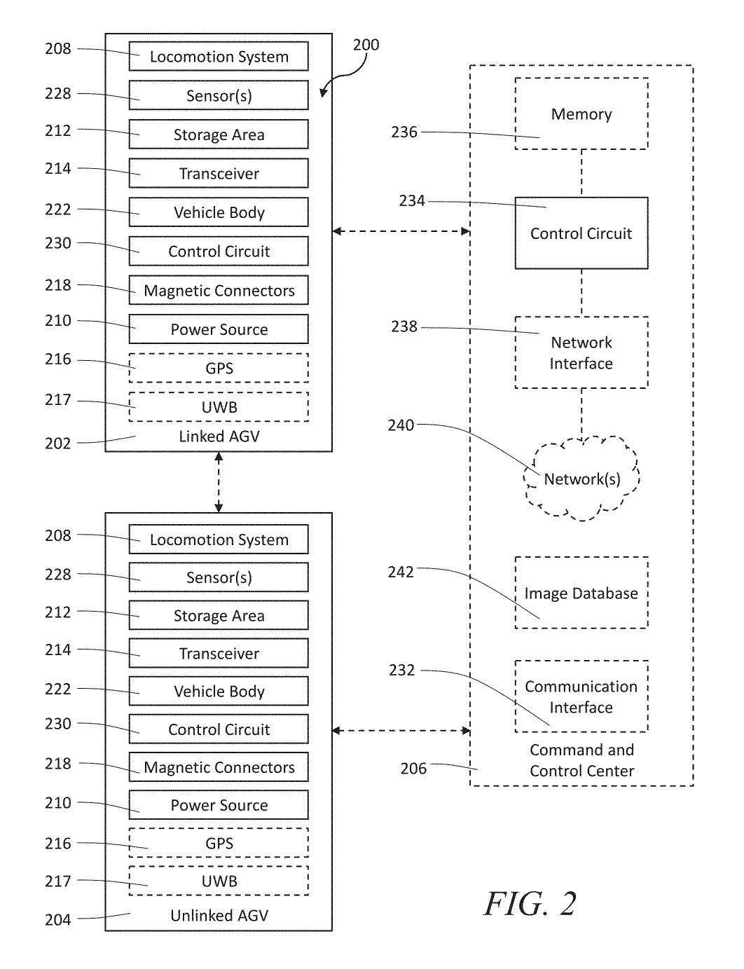

Referring to FIG. 2, there is shown a system 200 for the delivery of merchandise, such as from a retailer to customers. The system 200 includes a group of AGVs 202 and 204 that are generally similar in structure and interchangeable with one another. The system 200 includes linked AGVs 202 that form a chain of AGVs 202 and may be moving in a direction of travel (as shown in FIG. 2), and an unlinked AGV 204 that is to be joined to an end of the linked AGVs 202. The system 200 may include a command and control center 206 that communicates with the linked AGVs 202 and unlinked AGV 204. Alternatively, or in addition, one or more of the linked AGVs 202 may communicate with the unlinked AGV 204 (such as via a “smart” AGV).

The AGVs 202 and 204 include various components in order to deliver merchandise from a starting location (such as a retailer's store, product distribution center, etc.) to a destination location (such as a customer residence or business location). The AGVs 202 and 204 include a conventional motorized locomotion system 208 for facilitating movement of the AGV 202 and 204. It is generally contemplated that the motorized locomotion system 208 may include wheels (or tracks or legs), a motor, and a drive mechanism. The AGVs 202 and 204 each include a power source 210 (such as a battery or solar cell) disposed in vehicle body 222 to energize its motorized locomotion system 208 and other components.

In one form, the motorized locomotion system 208 may be navigated along a pre-programmed or calculated delivery route from the starting location to the destination location (or to a waypoint near the final destination location). Further, in one form, the motorized locomotion system 208 may be navigated by a human operator at the remote command and control center 206 as it nears the destination (such as from a waypoint near the destination to the final destination location) because more expert navigation may be required at this stage. For example, at this point, a human operator may navigate an AGV 202 when it decouples from the chain of AGVs 202 and individually travels to the final destination location.

The AGVs 202 and 204 also include a storage area 212 for holding the merchandise item(s) being delivered. The merchandise items may be of any type suitable for delivery, such as, for example, clothing, grocery, sporting goods, general retail merchandise, etc. In addition, the storage area 212 may be refrigerated and/or insulated for the delivery of perishable items, such as frozen or refrigerated grocery items. Also, the storage area 212 may be of any of various sizes and shapes. It may be relatively small for delivery of a single item per delivery and/or to conserve battery power. Alternatively, it may be relatively large to allow the storage of multiple merchandise items for delivery to different destinations.

In addition, the AGVs 202 and 204 include a transceiver 214 or other suitable communication device for wireless communication. It is generally contemplated that the AGV 202 and 204 will with communicate other AGVs 202 and 204 and/or with the command and control center 206. For example, when the fifth AGV 204 is linking to or unlinking from the chain of AGVs 202, it may communicate with the fourth AGV 202 to selectively activate or deactivate the magnetic connectors. Alternatively, the fifth AGV 204 may communicate with the command and control center 206 when it is coupling to or decoupling from the chain, and/or the fifth AGV 204 may communicate with the command and control center 206 at other times during delivery (such as upon completion of the delivery). Further, the AGVs 202 and 204 may each include a GPS tracking device 216, such as to facilitate navigation of the AGV 202 and 204 and/or tracking of the location of each of the AGVs 202 and 204 by the command and control center 206.

It is also contemplated that each AGV 202 and 204 may include an ultra-wideband unit 217 configured to facilitate navigation to, communication with, and connection with the other AGVs 202 and 204. Ultra-Wideband (UWB) may be used for short-range accurate, final layer, navigation (such as less than 300 meters). In one form, it is contemplated that the unlinked AGV 204 may be initially guided to the chain of AGVs 202 by GPS, and then, the unlinked AGV 204 may be guided in its final approach to the end AGV 202 by UWB.

Each of the AGVs 202 and 204 also includes two sets of magnetic connectors: a first set of magnetic connector(s) 218 located at the front end of vehicle body 222 and a second set of magnetic connector(s) 218 located at the back end of the vehicle body 222. It is generally contemplated that the front end of one AGV 202 and 204 may be linked to the back end of another AGV 202 and 204 via magnetic connectors 218. For example, the front end of the fifth, unlinked AGV 204 may be linked to the back end of the fourth, end AGV 202. The magnetic connectors 218 may be selectively activated and deactivated to couple and uncouple AGVs 202 and 204 from one another. Some specific types of magnetic connectors 218 that may be used will be described in further detail below.

The AGVs 202 and 204 may further include a variety of sensor(s), such as for navigation and for detecting obstacles in the AGV's path as it travels along its delivery route and to permit the AGVs 202 and 204 to stop if the sensor(s) detect an obstacle in the AGV's path. These sensor(s) may be of any of various types, including compasses and other navigational aids, gyroscopes, laser range finders, ultrasound range finders, and infrared sensors. It is generally contemplated that the AGVs 202 and 204 may include sensor(s) that allow the AGVs 202 and 204 to automatically stop when encountering an obstacle.

The AGVs 202 and 204 each include an optical/imaging sensor 228 (such as video/camera devices) configured to capture a plurality of images. These optical sensors 228 may serve a variety of purposes. For example, the AGVs 202 and 204 may use the optical sensors 228 to permit a human operator to remotely guide the AGV 202/204 at the end of the delivery route to its final merchandise drop-off location. However, as addressed further below, it is also contemplated that the optical sensors 228 are used to capture images of the front end and/or back end as the fifth, unlinked AGV 204 approaches the fourth, end AGV 202 to allow the unlinked AGV 204 to couple to the end AGV 202.

Each AGV 202 and 204 also includes a control circuit 230 that is operatively coupled to the various AGV components such that the control circuit 230 is configured to generally operate the AGVs 202 and 204. Further, in one aspect, each control circuit 230 is configured to selectively activate the first and second magnetic connectors 218 for linking to other AGVs 202 and to selectively deactivate the first and second connectors 218 for disconnecting from other AGVs 202. Being a “circuit,” the control circuit 230 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 230 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 230 is configured (for example, by using corresponding programming as will be well understood by those skilled in the art) to carry out one or more of the steps, actions, and/or functions described herein.

By one optional approach, the control circuit 230 may be operably coupled to a memory that can serve, for example, to non-transitorily store the computer instructions that, when executed by the control circuit 230, cause the control circuit 230 to behave as described herein. In one form, the control circuit 230 may also operably couple to a network interface that can compatibly communicate via whatever network or networks may be appropriate to suit the particular needs of the control circuit 230. However, in another form, it is generally contemplated that the control circuit 230 may not be directly coupled to a network interface and network because instead the AGVs 202 and 204 may be in communication with a command and control center 206 that may be coupled to a network interface and network.

Next, the system 200 optionally includes a command and control center 206 in communication with some or all of the AGVs 202 and 204. In one form, it is contemplated that the system 200 need not include a remote command and control center 206, but instead, the system 200 is controlled and operated by a local control circuit 230, such as that of a “smart” AGV 202 (or “mothership”). However, in one preferred form, the system 200 does include the command and control center 206 that communicates with and controls the operation of the AGVs 202 and 204 in some circumstances (such as by a human operator). The command and control center 206 may include a communication interface 232. This interface 232 may include various conventional components for communicating with the AGVs 202 and 204 and facilitating remote operation of the AGVs 202 and 204, such as joysticks, virtual reality and augmented reality interfaces, voice commands, radio transmitters/receivers/transceivers, mobile computing devices, computer programs, etc.

The system includes a control circuit 234 that controls the linking of unlinked AGV 204 to the AGV 202 at the end of the chain. In one form, this control circuit 234 may be remotely located at a command and control center 206. In other words, in one form, the control circuit 234 may be physically located at a command and control center 206 remote from the AGVs 202 and 204, and the control circuit 234 is in wireless communication with the AGV control circuits 230. However, in another form, the control circuit 234 may define a unitary control circuit with one or more of the local control circuits 230, such that the control circuit 234 is physically incorporated into the unlinked AGV 204, the end AGV 202, and/or a “smart” AGV 202 dedicated to the chain of AGVs 202.

Assuming a separate control circuit 234 at the command and control center 206, the control circuit 234 is communicatively coupled to the AGVs 202 and 204. Like the AGV control circuit 230, being a “circuit,” the control circuit 234 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 234 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 234 is configured (for example, by using corresponding programming as will be well understood by those skilled in the art) to carry out one or more of the steps, actions, and/or functions described herein.

By one optional approach, the control circuit 234 operably couples to a memory 236. This memory 236 may be integral to the control circuit 234 or can be physically discrete (in whole or in part) from the control circuit 234, as desired. This memory 236 can also be local with respect to the control circuit 234 (where, for example, both share a common circuit board, chassis, power supply, and/or housing) or can be partially or wholly remote with respect to the control circuit 234 (where, for example, the memory 236 is physically located in another facility, metropolitan area, or even country as compared to the control circuit 234).

This memory 236 can serve, for example, to non-transitorily store the computer instructions that, when executed by the control circuit 234, cause the control circuit 234 to behave as described herein. As used herein, this reference to “non-transitorily” will be understood to refer to a non-ephemeral state for the stored contents (and hence excludes when the stored contents merely constitute signals or waves), rather than volatility of the storage media itself, and hence includes both non-volatile memory (such as read-only memory (ROM)) as well as volatile memory (such as an erasable programmable read-only memory (EPROM).)

In this example, the control circuit 234 may also operably couple to a network interface 238. So configured, the control circuit 234 can communicate with other elements (both within the system 200 and external thereto) via the network interface 238. Network interfaces, including both wireless and non-wireless platforms, are well understood in the art and require no particular elaboration here. This network interface 238 can compatibly communicate via whatever network or networks 240 may be appropriate to suit the particular needs of a given application setting. Both communication networks and network interfaces are well understood areas of prior art endeavor and therefore no further elaboration will be provided here in those regards for the sake of brevity.

The control circuit 234 is configured to receive an authentication code from the unlinked AGV 204. This initial step is intended to make sure that that unlinked AGV 204 is an approved AGV 202/204 that is of a suitable type and/or authorized to travel with the chain of AGVs 202. In one form, for example, each AGV 202 and 204 may be assigned a unique serial number or string that can be recognized when transmitted by unlinked AGV 204. More specifically, it is contemplated that this authentication may involve a Wi-Fi beacon system where the AGVs 202/204 are generally broadcasting information (including the unlinked AGV 204). When this information is received (such as by the end AGV 202), it is authenticated to allow interaction and communication between the AGVs 202 and 204. This authentication can be accomplished through an internet authentication protocol, such as Wired Equivalent Privacy protocol (WEP), etc. The control circuit 234 then determines that the authentication code from the unlinked AGV 204 is an authorized authentication code to allow linking of the unlinked AGV 204 to the chain of AGVs 202. As should be evident, there are a number of types of authentication codes and protocols that may be used.

After the unlinked AGV 204 has been authenticated, information will be exchanged regarding the unlinked AGV 204 and the end AGV 202. This information will include speed, direction, position, etc., of the unlinked AGV 204 and end AGV 202. This information can be sourced from the AGV's GPS/Differential GPS or onboard navigation tools.

The control circuit 234 is configured to position the unlinked AGV 204 in proximity to the end AGV 202 of the chain. More specifically, the control circuit 234 determines a first position, first speed, and first direction of the end AGV 202 at the end of the chain of AGVs 202 to be linked to the unlinked AGV 204. It then determines a second position, second speed, and second direction of movement of the unlinked AGV 204. The control circuit 234 then calculates and transmits a third speed and third direction of movement to the unlinked AGV 204 to facilitate approach to the end AGV 202. It is contemplated that either the chain of AGVs 202 and/or the unlinked AGV 204 may initially be in a stopped position in order to facilitate linking of the unlinked AGV 204 to the chain.

When two or more AGVs are linking together, continuous communication is used to share and distribute positioning information, such as current location, speed, direction, etc. Sensors are used as the front of unlinked AGV 204 comes in close proximity to and makes a final approach to the back of end AGV 202. For example, the sensors might include an infrared sensor disposed on the front of the unlinked AGV 204 and on the rear of the end AGV 202. So, the unlinked AGV 204 approaches the other AGV 202 through the readings it receives from the infrared sensor. In essence, it is using a sensor to finalize the approach. The proximity of the two AGVs 202 and 204 can also be determined through active communication between the two AGVs 202 and 204 by sharing their current navigation information. Sensors, such as the infrared sensors mentioned above, can also assist in the coupling process, by their ability to sync two or more sensors, which provide some distance and direction between.

It is contemplated that the optical sensor 228 may be used in a similar manner. This approach generally involves the use of a database 242 of known images or videos relating to images for connecting two or more AGVs 202 and 204. In one form, this approach may be accomplished by the use of a license plate on each AGV 202 and 204. In this example, the system 200 would have a collection of license plates in the database 242. These license plates may have key features identified regarding the size of the plate, the characters on the plate, the depth of the characters, etc. So, when a license plate is being scanned by the optical sensor 228 onboard one AGV 204 approaching another AGV 202, the control circuit 234 may compare the features from the optical sensor 228 against the known features contained in the database 242. Once a match has been established, the AGV 202 and 204 can then contrast the image against the known image for information relating to size, angle of perception, etc., to determine proximity and orientation. In other words, the control circuit 234 can compute distance from the plate by contrasting the plate's size against the known plate, and the angle from which the image was taken can be contrasted against a known plate in the database 242 to determine direction and orientation.

In other words, this image recognition approach generally involves the use of a database 242 of known images associated with AGVs during coupling or decoupling. In FIG. 2, this database 242 is located at the command and control center 206, but it should be understood that the database 242 may be physically located at and/or accessed at any of various, such as at one or more AGVs 202 or at a cloud database. These known images will be compared to the video or still images captured by the optical sensors 228 at the time of coupling. The captured imagery may be processed and fragmented for key features related to known AGV images, such as rear end AGV features, sensors, front end AGV features, etc. Image processing may involve image gradient detection, thresholding, kernelization, erosion and dilation (morphological image processing), and other well know image processing techniques. These image processing techniques may be used to assist in determining depth, direction, facing, etc., of the unlinked AGV 204 and end AGV 202.

In summary, the control circuit 234 receives a plurality of images from the optical sensor 228 of one or both of the unlinked AGV 204 and the end AGV 202. It then compares the received plurality of images with predetermined images from the database 242 using image recognition of predetermined features of the first and second ends of the AGV vehicle body 222 to determine the proximity and orientation of the unlinked AGV 204 with respect to the end AGV 202 on approach to linking to the chain of AGVs 202. The control circuit 234 then instructs the activation of the magnetic connector(s) 218 of one or both of the unlinked AGV 204 and the end AGV 202 to link the unlinked AGV 204 to the end AGV 202 when the unlinked AGV 204 is within a predetermined proximity and orientation to the end AGV 202.

After linking, it is contemplated that the chain of AGVs 202 (now also including AGV 204) may travel along a delivery route to a neighborhood or geographic area. In one form, it is contemplated that the AGVs 202 may share power with one another. For example if one AGV 202 has a power level below a predetermined level, i.e., 25% battery life, it may be charged by an adjacent AGV 202 having a higher power level. In other words, a first AGV 202 may be linked to a second AGV 202 in the plurality of AGVs 202, and the control circuit 230 of the first AGV 202 may be configured to transfer power from its power source 210 to the second AGV 202 through the magnetic coupling between the first and second AGVs 202. In another form, it is contemplated that each chain of AGVs 202 may include a special, dedicated AGV 202 that may have a specialized high level power source or may have multiple power sources so as to be able to share power with other AGVs.

Further, during the course of travel, individual AGVs 202 may couple and decouple from the chain of AGVs for various reasons. In other words, the control circuit 234 may be configured to communicate with the control circuits 230 of the AGVs 202 and instruct the control circuit 230 of an AGV 202 to selectively connect with other AGVs 202 to form a chain of AGVs 202 and to selectively disconnect from other AGVs 202 to unchain. For example, as the chain of AGVs 202 approaches a navigational waypoint or the final delivery location for one of the AGVs 202, that AGV 202 may decouple from the chain of AGVs 202 in order to make the final approach to the delivery location. The chain of AGVs 202 may also decouple from one another in order to avoid an obstacle that is detected in the travel path of the chain. In other words, the control circuit 234 may be configured to detect an obstacle in a direction of travel of the linked AGVs 202 and communicate with the control circuits 230 of the AGVs 202 instructing them to selectively disconnect from the other AGVs 202 to avoid the obstacle.

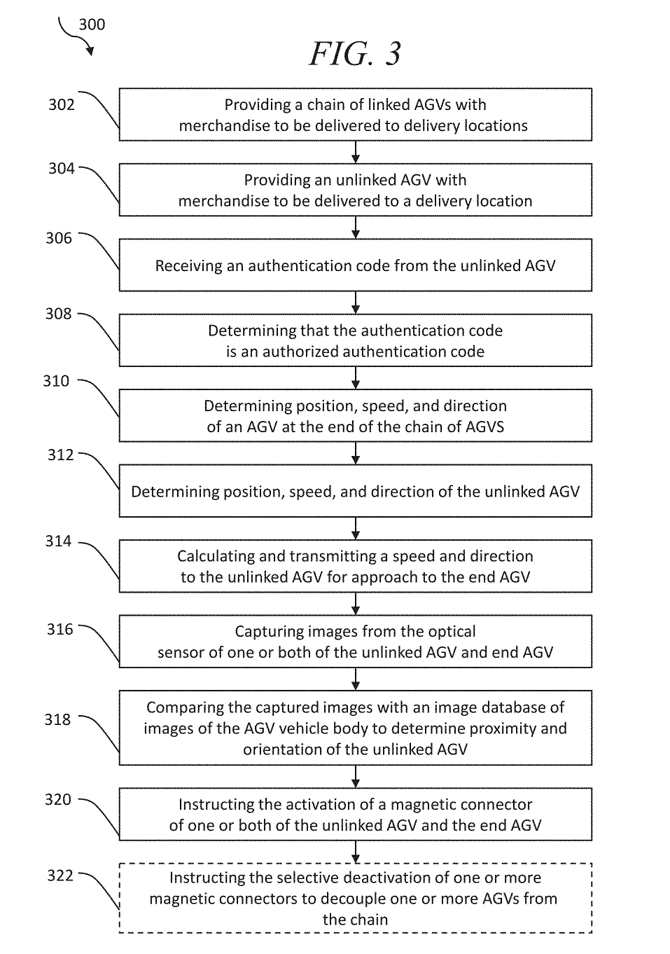

Referring to FIG. 3, there is shown a process 300 for delivering merchandise using a chain of AGV. The process 300 provides an approach for linking a chain of AGVs to an unlinked AGV. In one form, it is contemplated that the chain of AGVs travels along a delivery route to a certain geographical area where individual AGVs may decouple and travel to their individual delivery locations. The process 300 may use some or all of the components of the systems 100 and 200 described above.

At block 302, a chain of AGVs is provide for transporting merchandise for delivery to delivery locations. It is generally contemplated that the AGVs will include components needed for performing the delivery, including a motorized locomotion system, a storage area for holding the merchandise item, a vehicle body with front and back ends, a power source, magnetic connectors on the front and back ends for coupling to other AGVs, a transceiver for wireless communication, an optical sensor to capture images, and a control circuit for moving and operating the AGV. These components may be those described above with respect to systems 100 and 200. It is generally contemplated that the AGVs are generally modular and interchangeable to facilitate the ability for one AGV to connect to another. However, there may be certain specialized AGVs, such as a “smart” AGV that communicates with and controls the other “dumb” AGVs and an AGV dedicated to power sharing with other AGVs (that may have a specialized high level power source or multiple power sources).

At block 304, an unlinked AGV is provided that also is intended to deliver merchandise to a delivery location. The unlinked AGV is intended to be coupled to an end of the linked AGVs. It is generally contemplated that the linked AGVs and the unlinked AGV are making deliveries in the same neighborhood or geographic area such that the linked AGVs and the unlinked AGV can efficiently travel together. More specifically, they can travel together as a group along a common delivery route to one or more waypoints where individual AGVs may then uncouple to complete the transport to their final delivery locations (such as customer businesses or residences). This linking may occur at various points of the delivery process, such as at a common starting location for the AGVs (a product distribution center, a shopping facility, a drop off location from a delivery truck, etc.). Alternatively, it is contemplated that the unlinked AGV may be a separate, isolated AGV that can be navigated to a linked chain of AGVs that is travelling nearby to a waypoint near the unlinked AGV's final delivery location. By traveling together, the AGVs can share resources with one another, such as sharing power and sharing navigational information and guidance.

At block 306, an authentication code is received from the unlinked AGV to confirm that it is authorized to link up with the chain of AGVs. In one form, this authentication may involve a Wi-Fi beacon system where the AGVs are generally broadcasting their authentication codes. Alternatively, the unlinked AGV may provide the authentication code in response to a query from another AGV or from a remote command and control center. This authentication code and authentication protocol may take any of various forms, such as, for example, a unique serial number or string or an internet authentication protocol, such as WEP, etc.

At block 308, it is determined that the authentication code is an authorized authentication code. It is contemplated that this determination may be made by another AGV (such as the end AGV or the “smart” AGV in the chain of AGVs) or may be made by a remote command and control center. In one form, the authentication code transmitted by the unlinked AGV may be matched to approved authentication codes from a database. Alternatively, the authentication determination may be made in accordance with any of various known wireless authentication protocols. Once the authentication code is approved, the linking of the unlinked AGV proceeds to the next step.

At block 310, the position, speed, and direction of the end AGV in the chain of linked AGVs is determined. It is generally contemplated that this movement information will be determined by or transmitted to a “smart” AGV in the chain of AGVs or to a remote command and control center. This information can be sourced from the end AGV's GPS/Differential GPS or onboard navigation tools. In one form, it is contemplated that the end AGV is initially in an “at rest” state to facilitate coupling such that the speed and direction of the end AGV are zero. For example, the end AGV may be in an “at rest” state where both the end AGV and unlinked AGV are at a common starting location (distribution center, shopping facility, delivery truck drop off location, etc.).

At block 312, the position, speed, and direction of the unlinked AGV is determined. As with the end AGV, it is generally contemplated that this movement information will be determined by or transmitted to a “smart” AGV in the chain of AGVs or to a remote command and control center, and this information can be sourced from the end AGV's GPS/Differential GPS or onboard navigation tools. Like the end AGV, the unlinked AGV may initially start from an “at rest” state such that the speed and direction of the end AGV are zero. In other words, either one or both of the end and unlinked AGVs may start from a stopped position, such as when both are generally starting from a common starting location.

At block 314, a speed and direction are calculated and transmitted for navigating the approach to the general vicinity of the end AGV. It is generally contemplated that this navigation will place the unlinked AGV in close proximity to the end AGV where optical sensors and magnetic connectors can then be used to couple the two AGVs. Further, the speed and direction may be calculated at an AGV (such as by a “smart” AGV travelling in the chain) or at a remote command and control center. In one form, one or both of the end and unlinked AGVs may start from “at rest” positions, which may simplify this calculation. In another form, an intercept course may be calculated and plotted enabling the unlinked AGV to intercept the linked AGVs if they are already in transit.

At block 316, images from the optical sensors of one or both the unlinked AGV and end AGV are captured. It is generally contemplated that the unlinked AGV has been navigated to the general vicinity of the end AGV. Images of the back end of the end AGV and the front end of the unlinked AGV are then captured to enable a final approach and connection by the unlinked AGV. In one form, the front and back ends of the AGVs may have license plates, including key features regarding the size of the plate, the characters on the plate, the depth of the characters, etc. Alternatively, the AGVs may generally be modular and interchangeable such that their front ends have specific, consistent recognizable features and their back ends similarly have consistent features. These features may be used to guide the positioning and orientation of the unlinked AGV relative to the end AGV.

At block 318, the captured images from the optical sensors are compared to images from an image database to determine this proximity and orientation of the unlinked AGV relative to the end AGV. In other words, the features in the captured images are compared against the known features contained in the image database. Once a match has been established, the captured imagery may be processed for key features related to known AGV images, i.e., rear end AGV features and front end AGV features, and image processing techniques may be used, such as image gradient detection, thresholding, kernelization, and erosion and dilation (morphological image processing). These image processing techniques may be used to determine distance and orientation, and navigational adjustments may be made to position the unlinked AGV closer and in a more direct facing orientation to the end AGV.

At block 320, activation of the magnetic connectors of one or both the end and unlinked AGVs is instructed. It is generally contemplated that, prior to activation, the unlinked AGV is within a certain maximum distance and/or with a certain orientation relative to the end AGV. For example, this maximum distance may be 10 centimeters (or about 4 inches) with an offset of 5 centimeters (or about 2 inches). Once this predetermined distance and orientation are achieved, the magnetic connectors may be activated to complete the coupling.

At block 322, the selective deactivation of one or more magnetic connectors is instructed in order to decouple one or more AGVs from the chain of AGVs. In one form, it is contemplated this instruction may be transmitted by a “smart” AGV or by a remote command and control center. This decoupling may be desirable in several circumstances. For example, one of the AGVs may have reached a waypoint where it is desirable in order to proceed individually to that AGV's final delivery location. In this example, the particular AGV may decouple, and the remaining AGVs may then recouple in order to re-form the chain of AGVs. In another example, the traveling chain of AGVs may encounter an obstacle such that it is desirable for the AGVs to decouple in order to circumvent the obstacle. Again, once the AGVs have bypassed the obstacle, the AGVs may then recouple in order to re-form the chain. The AGVs may recouple and re-form the chain by following the steps provided above for coupling an unlinked AGV to an end AGV.

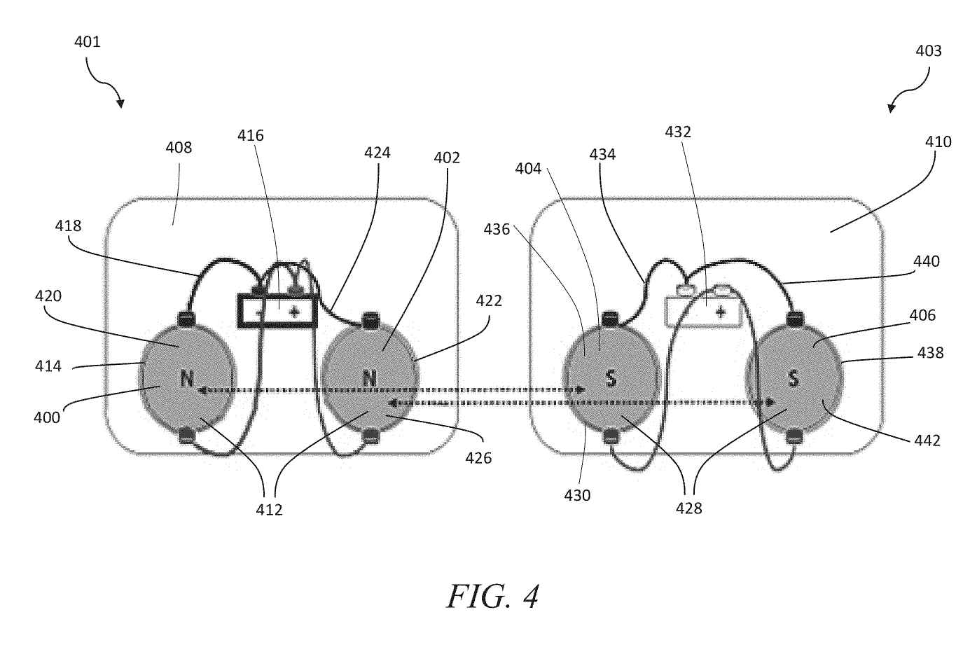

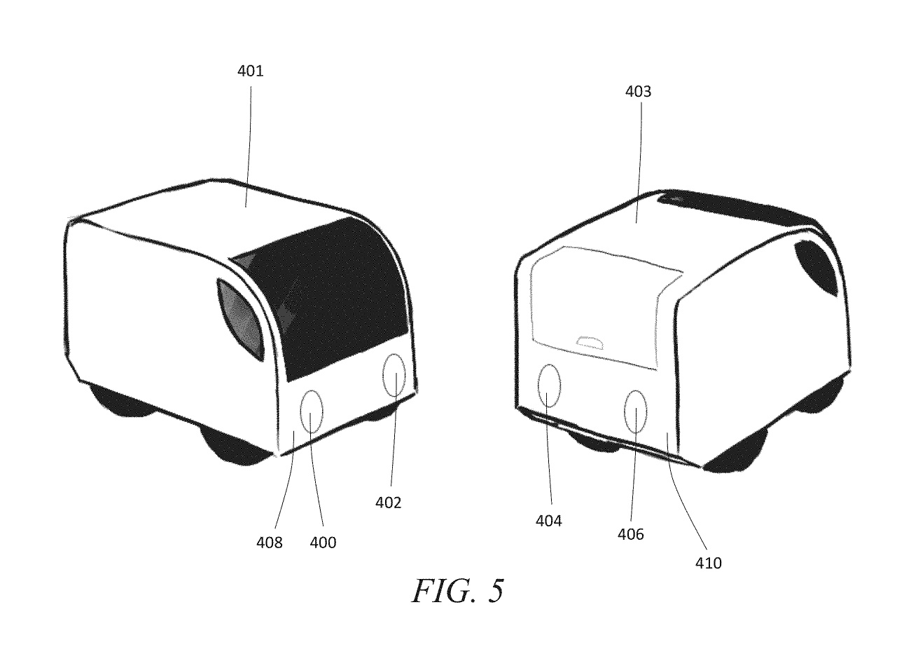

FIGS. 4 and 5 show one example of magnetic connectors for coupling AGVs to one another (electromagnetic connectors). As stated above, these magnetic connectors must be capable of selective activation and deactivation by the control circuit of each AGV in order to create a chain of AGVs and to separate from the chain of AGVs during the delivery process. The control circuit must be able to adjust the polarity of the magnetic connectors. The magnetic connectors cannot be fixed and unchanging in polarity such that they will remain coupled to other magnets unless a physical force is exerted against them to separate them.

FIGS. 4 and 5 show two sets of electromagnetic connectors: a first set including two electromagnetic connectors 400 and 402 and a second set of two electromagnetic connectors 404 and 406. The first set of electromagnetic connectors 400 and 402 are disposed on the front end 408 of one AGV 401. The second set of electromagnetic connectors 404 and 406 are disposed on the rear end 410 of a second AGV 403. It is generally contemplated that the AGVs are modular and interchangeable such that the front end 408 and rear end 410 of each AGV includes the first and second sets of electromagnetic connectors 400, 402, 404, and 406. As should be evident, the number of electromagnetic connectors on the front and rear ends need not be two and may be reduced or increased, as desired.

As can be seen in FIG. 4, the front end electromagnetic connector(s) 412 of the AGV 401 include a first coiled wire 414 coupled to the AGV power source (battery 416) and receiving current, such as via power cables 418. The first coiled wire 414 is wrapped around a first metal core 420 to define the first electromagnetic connector 400. The front end electromagnetic connector(s) 412 of the AGV 401 also includes a second coiled wire 422 coupled to the AGV power source (battery 416) and receiving current, such as via power cables 424. The second coiled wire 422 is wrapped around a second metal core 426 to define the second electromagnetic connector 402. In this example, the polarity of the electromagnetic connectors 400 and 402 each define a north pole at the front end 408 of the AGV.

Conversely, the rear end electromagnetic connector(s) 428 of the AGV 403 include a third coiled wire 430 coupled to the AGV power source (battery 432) and receiving current, such as via power cables 434. The third coiled wire 430 is wrapped around a third metal core 436 to define the third electromagnetic connector 404. The rear end electromagnetic connector(s) 428 of the AGV 403 also includes a fourth coiled wire 438 coupled to the AGV power source (battery 432) and receiving current, such as via power cables 440. The fourth coiled wire 438 is wrapped around a fourth metal core 442 to define the fourth electromagnetic connector 406. In this example, the polarity of the electromagnetic connectors 404 and 406 each define a south pole at the rear end 410 of the AGV 403.

During operation of the AGVs, each AGV control circuit is configured to selectively adjust the polarity of the front end electromagnetic connector(s) 412 or the rear end electromagnetic connector(s) 428. In one form, the AGV control circuit causes the current to run through the coiled wires to create a north or south pole at the AGV front end 408 or rear end 410. The control circuit may then stop the current such that the electromagnetic connector has no pole, i.e., the polarity may be switched from being either a north pole or south pole to having no pole. In this manner, the control circuit may selectively activate or deactivate the electromagnetic connectors 412 or 428 to couple or decouple AGVs 401 and 403.

In summary, while AGVs are travelling, there may be a need for these vehicles to function together in a chain, with seamless connection and disconnection. Under this approach, AGVs are able to connect to one another through electromagnetically charged surfaces that are affixed to the front and rear panels of the AGVs. These electromagnets may be charged by each AGV's battery reservoir (or other power source). The battery connects to a coil system (such as copper), which is then wrapped around a metal core to create an electromagnetic field. For connection, the AGV may supply a current to its magnet, which will emit an electromagnetic field to the other AGV's electromagnet. The front of the AGV may feature a north pole for the electromagnet, while the rear of the AGV may feature a south pole for connection to the north pole of another AGV. For disconnection, the AGV may stop current to its magnet, which will eliminate the electromagnetic field of connection between the two AGVs. The connection and disconnection will be controlled by the AGV's onboard control circuit or via wireless connection to a remote command and control system (or network system), which will determine when the AGV needs to connect or disconnect with another AGV.

It is also contemplated that the polarity of the electromagnetic connector(s) 412 and 428 may be adjusted in other ways. In one form, it is contemplated that that pole of the electromagnetic connector(s) 412 and 428 may be switched from north pole to south pole and vice versa. As one example, each AGV control circuit may be configured to selectively reverse the polarity of the front end electromagnetic connector(s) 412 or the rear end electromagnetic connector(s) 428 by causing the current through the coiled wires to be reversed. As a second example, each AGV control circuit may be configured to selectively reverse the polarity of the front end electromagnetic connector(s) 412 or the rear end electromagnetic connector by causing rotation of the coiled wires. In some circumstances, it may be desirable to reverse the polarity of the electromagnetic connectors 412 and 428 in order to repel AGVs that may be too close to one another or that may be oriented incorrectly with respect to one another.

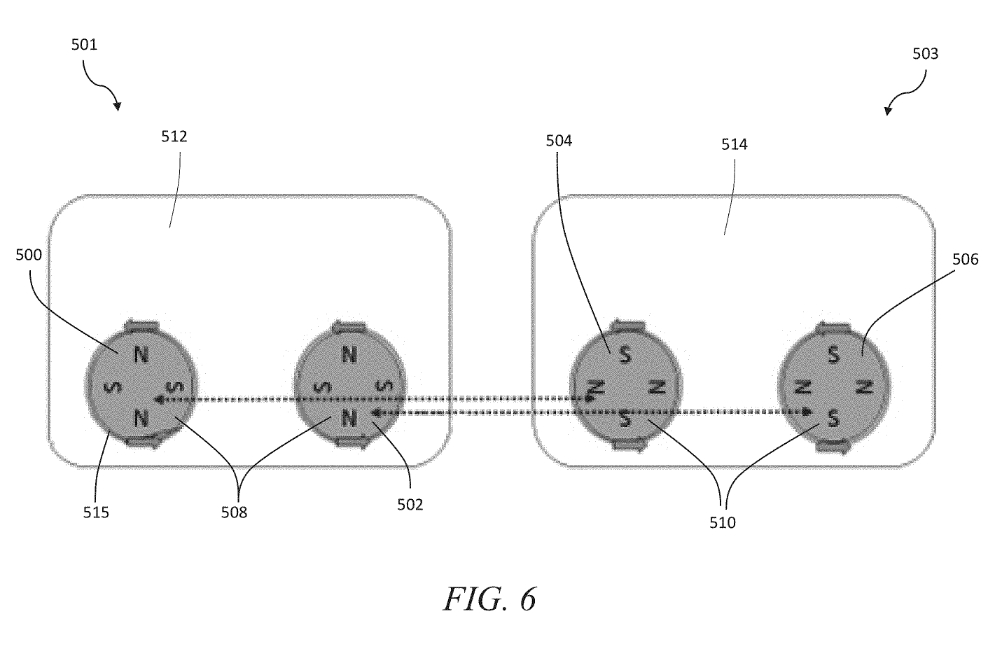

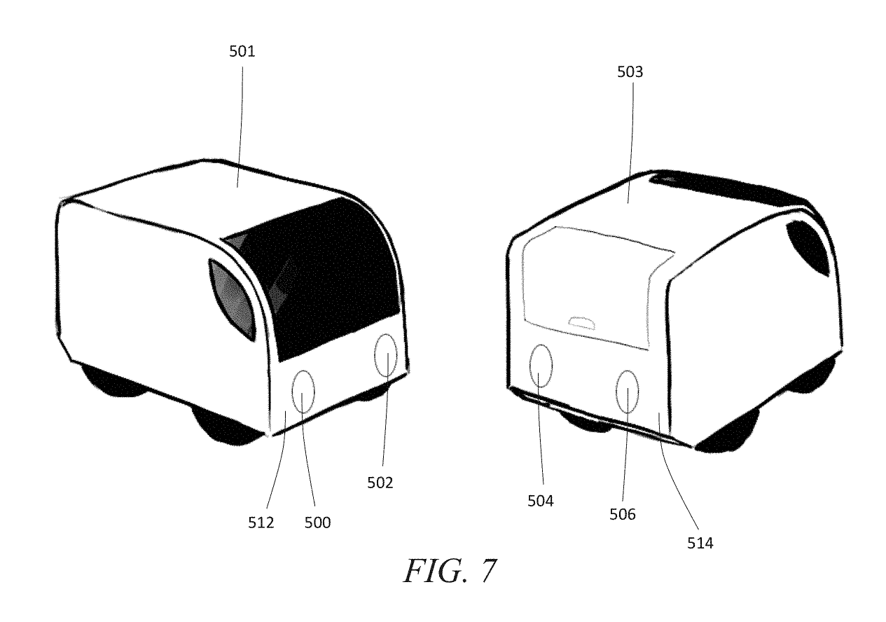

FIGS. 6 and 7 show a second example of magnetic connectors for coupling AGVs to one another (multi-pole magnetic connectors). A multi-pole magnetic connector is generally a connector that has multiple poles, i.e., more than just one north pole or one south pole. As addressed further below, these multi-pole magnetic connectors are capable of selective activation and deactivation by the control circuit via rotation of the multi-pole magnetic connector. In one orientation, two multi-pole magnetic connectors may attract one another to allow coupling of two AGVs, but when this orientation is rotated a certain amount, the two multi-pole magnetic connectors may no longer attract one another (and may actually repel one another) to allow decoupling of two AGVs.

FIG. 6 shows one arrangement of the poles of four multi-pole magnetic connectors 500, 502, 504, and 506. As can be seen, the front end magnetic connector(s) 508 include two multi-pole magnetic connectors 500 and 502, and the rear end magnetic connector(s) 510 includes two multi-pole magnetic connectors 504 and 506. Each of the four multi-pole magnetic connectors 500, 502, 504, and 506 have two north poles that alternate with two south poles. As should be evident, other arrangements of poles are possible.

In other words, FIGS. 6 and 7 show two sets of multi-pole magnetic connectors: a first set including two multi-pole magnetic connectors 500 and 502 and a second set of two multi-pole magnetic connectors 504 and 506. The first set of multi-pole magnetic connectors 500 and 502 are disposed on the front end 512 of one AGV 501. The second set of multi-pole magnetic connectors 504 and 506 are disposed on the rear end 514 of a second AGV 503. It is generally contemplated that the AGVs are modular and interchangeable such that the front end 512 and rear end 514 of each AGV includes the first and second sets of multi-pole magnetic connectors 500, 502, 504, and 506. As should be evident, the number of multi-pole magnetic connectors on the front and rear ends need not be two and may be reduced or increased, as desired.

As can be seen in FIG. 6, the front end multi-pole magnetic connector(s) 508 of the AGV 501 are in a first orientation where they will attract the rear end multi-pole magnetic connector(s) 510 of AGV 503. More specifically, the orientation of the multi-pole magnetic connectors 508 and 510 are such that a north pole on the front end multi-pole magnetic connectors 508 is aligned with a corresponding south pole on the rear end multi-pole magnetic connectors 510. Similarly, the south poles on the front end multi-pole magnetic connectors 508 are aligned with corresponding north poles on the rear end multi-pole magnetic connectors 510. Thus, in this orientation, the front end 512 of AGV 501 is attracted to the rear end 514 of AGV 503.

In a second orientation, the front end multi-pole magnetic connector(s) 508 of the first AGV 501 will repel the rear end multi-pole magnetic connector(s) 510 of the second AGV 503. More specifically, if the multi-pole magnetic connectors 500 and 502 are rotated 90 degrees, their north poles and south poles will be aligned with those same poles of the multi-pole magnetic connectors 504 and 506. Because the same poles are aligned with one another, the multi-pole magnetic connectors 500 and 504 and the multi-pole magnetic connectors 502 and 506 will repel one another.

So, during operation of the AGVs, each AGV control circuit is configured to selectively adjust the polarity of the front end multi-pole magnetic connector(s) 508 or the rear end multi-pole magnetic connector(s) 510. In one form, each multi-pole magnetic connector 500, 502, 504, and 506 is rotatable within its mounting, and each AGV control circuit operates a motor coupled to the multi-pole magnetic connector 500, 502, 504, and 506 (or some other turning or rotation mechanism 515) that rotates the multi-pole magnetic connector 500, 502, 504, and 504. In the first orientation, the poles of the multi-pole magnetic connectors 500, 502, 504, and 506 are arranged so that the AGVs 501 and 503 attract one another and can couple to one another. When the control circuit rotates either the front end multi-pole magnetic connector(s) 508 or the rear end multi-pole magnetic connector(s) 510 to the second orientation, the poles are switched so that the AGVs 501 and 503 repel one another and can decouple. In this manner, the control circuit may selectively activate or deactivate the multi-pole magnetic connectors 508 and 510 to couple or decouple AGVs 501 and 503.

In summary, in one form under this approach, AGVs are able to connect to one another through multi-pole magnetic connections on their surfaces, which are affixed to the front and rear panels of an AGV. Each multi-pole magnet is rotatable to change its polarity, and a turning mechanism may be used to rotate it. For connection of two AGVs, the multi-pole magnets may be coupled to turning mechanisms that will position the poles of one or both magnets of the two AGVs in such a way as to have the reciprocal poles aligned with each other. For disconnection of two AGVs, the turning mechanisms may turn one or both magnets in such a way as to have the same poles facing each other, which will therefore break the magnetic attraction and disconnect the AGVs. These orientations are controlled by the AGV's onboard control circuit, which will determine when the AGV needs to connect or disconnect. The AGV's onboard control circuit may be connected wirelessly to a remote command and control center (or network system) for operation.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system of delivering merchandise using autonomous ground vehicles linking to other autonomous ground vehicles, the system comprising:
a plurality of autonomous ground vehicles, each autonomous ground vehicle (AGV) comprising:
a motorized locomotion system configured to facilitate movement of the AGV;
a storage area configured to hold at least one merchandise item;
a vehicle body having a first end and a second end;
a power source disposed in the vehicle body;
a first magnetic connector at the first end of the vehicle body and configured for linking to a magnetic connector of another AGV;
a second magnetic connector at the second end of the vehicle body and configured for linking to a magnetic connector of another AGV;
a transceiver configured for wireless communication and configured to transmit an authentication code;
an optical sensor configured to capture a plurality of images;
a first control circuit configured to selectively activate the first and second magnetic connectors for linking to other AGVs and to selectively deactivate the first and second connectors for disconnecting from other AGVs;
a subset of the plurality of AGVs defining a chain of AGVs moving in a direction of travel to deliver merchandise;
an unlinked AGV of the plurality of AGVs to be linked to an AGV at an end of the chain of AGVs;
a database containing a plurality of predetermined images of the first end of the AGV vehicle body and of the second end of the AGV vehicle body;
a second control circuit configured to:
receive an authentication code from the unlinked AGV;
determine that the authentication code from the unlinked AGV is an authorized authentication code to allow linking of the unlinked AGV to the chain of AGVs;
determine a first position, first speed, and first direction of the end AGV at the end of the chain of AGVs to be linked to the unlinked AGV;
determine a second position, second speed, and second direction of movement of the unlinked AGV;
calculate and transmit a third speed and third direction of movement to the unlinked AGV to facilitate approach to the end AGV;
receive a plurality of images from the optical sensor of one or both of the unlinked AGV and the end AGV;
compare the received plurality of images with predetermined images from the database using image recognition of predetermined features of the first and second ends of the AGV vehicle body to determine a proximity and orientation of the unlinked AGV with respect to the end AGV on approach to link; and
instruct the activation of a magnetic connector of one or both of the unlinked AGV and the end AGV to link the unlinked AGV to the end AGV when the unlinked AGV is within a predetermined proximity and orientation to the end AGV.

2. The system of claim 1, wherein the second control circuit is physically located at a command and control center remote from the chain of AGVs, the second control circuit in wireless communication with each first control circuit of the plurality of AGVs.

3. The system of claim 1, wherein the second control circuit defines a unitary and master control circuit with one of the first control circuits of the linked AGVs.

4. The system of claim 1, wherein:
each first magnetic connector of an AGV comprises a first coiled wire coupled to the AGV power source and receiving current, the first coiled wire wrapped around a first metal core to define a first electromagnetic connector;
each second magnetic connector of the AGV comprises a second coiled wire coupled to the AGV power source and receiving current, the second coiled wire wrapped around a second metal core to define a second electromagnetic connector; and
each first control circuit is configured to selectively adjust the polarity of the first electromagnetic connector or the second electromagnetic connector by adjusting the current through the first coiled wire or the second coiled wire.

5. The system of claim 1, wherein:
each first magnetic connector of an AGV comprises a first coiled wire coupled to the AGV power source and receiving current, the first coiled wire wrapped around a first metal core to define a first electromagnetic connector;
each second magnetic connector of the AGV comprises a second coiled wire coupled to the AGV power source and receiving current, the second coiled wire wrapped around a second metal core to define a second electromagnetic connector; and
each first control circuit is configured to selectively reverse the polarity of the first electromagnetic connector or the second electromagnetic connector.

6. The system of claim 1, wherein each first and second magnetic connector of each AGV of the plurality of AGV comprises a first and second multi-pole magnetic connector, each first and second multi-pole magnetic connector having two north poles alternating with two south poles.

7. The system of claim 6, wherein:
each multi-pole magnetic connector has a first predetermined orientation;
each multi-pole magnetic connector has a second predetermined orientation corresponding to a predetermined degree of rotation from the first orientation;
each multi-pole magnetic connector in the first predetermined orientation attracts another multi-pole magnetic connector in the second predetermined orientation; and
each multi-pole magnetic connector in the first predetermined orientation repels another multi-pole magnetic connector in the first predetermined orientation.

8. The system of claim 1, wherein each AGV further comprises a navigational system including:
a GPS unit configured to facilitate navigation of the AGV vehicle body; and
an ultra-wideband unit configured to facilitate navigation to and connection with the other AGVs of the plurality of AGVs.

9. The system of claim 1, wherein:
a first AGV is linked to a second AGV in the plurality of AGVs; and
the first control circuit of the first AGV is configured to transfer power from its power source to the second AGV through magnetic coupling between the first and second AGVs.

10. The system of claim 1, wherein the second control circuit is configured to:
communicate with the first control circuit of each AGV of the plurality of AGVs; and
instruct the first control circuit of each AGV to selectively connect with other AGVs to form a chain of AGVs and to selectively disconnect from other AGVs to unchain.

11. The system of claim 1, wherein the second control circuit is configured to:
detect an obstacle in a direction of travel of the linked AGVs;
communicate with the first control circuits of the AGVs instructing them to selectively disconnect from other AGVs to avoid the obstacle.

12. A method of delivering merchandise using autonomous ground vehicles linking to other autonomous ground vehicles, the method comprising:
providing a plurality of autonomous ground vehicles, each autonomous ground vehicle (AGV) comprising:
a motorized locomotion system configured to facilitate movement of the AGV;
a storage area configured to hold at least one merchandise item;
a vehicle body having a first end and a second end;
a power source disposed in the vehicle body;
a first magnetic connector at the first end of the vehicle body and configured for linking to a magnetic connector of another AGV;
a second magnetic connector at the second end of the vehicle body and configured for linking to a magnetic connector of another AGV;
a transceiver configured for wireless communication and configured to transmit an authentication code;
an optical sensor configured to capture a plurality of images;
a first control circuit configured to selectively activate the first and second magnetic connectors for linking to other AGVs and to selectively deactivate the first and second connectors for disconnecting from other AGVs;
linking a subset of the plurality of AGVs to define a chain of AGVs moving in a direction of travel to deliver merchandise;
providing an unlinked AGV of the plurality of AGVs to be linked to an AGV at an end of the chain of AGVs;
providing a database containing a plurality of predetermined images of the first end of the AGV vehicle body and of the second end of the AGV vehicle body;
by a second control circuit:
receiving an authentication code from the unlinked AGV;
determining that the authentication code from the unlinked AGV is an authorized authentication code to allow linking of the unlinked AGV to the chain of AGVs;
determining a first position, first speed, and first direction of the end AGV at the end of the chain of AGVs to be linked to the unlinked AGV;
determining a second position, second speed, and second direction of movement of the unlinked AGV;
calculating and transmitting a third speed and third direction of movement to the unlinked AGV to facilitate approach to the end AGV;
receiving a plurality of images from the optical sensor of one or both of the unlinked AGV and the end AGV;
comparing the received plurality of images with predetermined images from the database using image recognition of predetermined features of the first and second ends of the AGV vehicle body to determine a proximity and orientation of the unlinked AGV with respect to the end AGV on approach to link; and
instructing the activation of a magnetic connector of one or both of the unlinked AGV and the end AGV to link the unlinked AGV to the end AGV when the unlinked AGV is within a predetermined proximity and orientation to the end AGV.

13. The method of claim 12, wherein the second control circuit is physically located at a command and control center remote from the chain of AGVs, the second control circuit in wireless communication with each first control circuit of the plurality of AGVs.

14. The system of claim 12, wherein the second control circuit defines a unitary and master control circuit with one of the first control circuits of the linked AGVs.

15. The method of claim 12, wherein each first and second magnetic connector of each AGV comprises a first electromagnetic connector and a second electromagnetic connector.

16. The method of claim 12, wherein each first and second magnetic connector of each AGV of the plurality of AGV comprises a first multi-pole magnetic connector and a second multi-pole magnetic connector.

17. The method of claim 12, wherein each AGV further comprises a navigational system including:
a GPS unit configured to facilitate navigation of the AGV vehicle body; and
an ultra-wideband unit configured to facilitate navigation to and connection with the other AGVs of the plurality of AGVs.

18. The method of claim 12, further comprising:
linking a first AGV to a second AGV in the plurality of AGVs; and
transferring power from the power source of the first AGV to the second AGV through magnetic coupling between the first and second AGVs.

19. The method of claim 12, further comprising, by the second control circuit:
communicating with the first control circuit of each AGV of the plurality of AGVs; and
instructing the first control circuit of each AGV to selectively connect with other AGVs to form a chain of AGVs and to selectively disconnect from other AGVs to unchain.

20. The method of claim 12, further comprising, by the second control circuit:
detecting an obstacle in a direction of travel of the linked AGVs;
communicating with the first control circuits of the AGVs instructing them to selectively disconnect from other AGVs to avoid the obstacle.
